(19) United States
(12) Patent Application Publication
(10) Pub. No.: US 2015/0000498 A1
(43) Pub. Date: Jan. 1, 2015

(54) MUSIC BOX IMPROVING SOUND QUALITY

(71) Applicants: BROTHER KOGYO KABUSHIKI KAISHA, Nagoya (JP); NIDEC SANKYO CORPORATION, Nagano (JP)

(72) Inventors: Akito UEKIHARA, Nagoya-shi (JP); Katsuhiro YAMAZAKI, Suwa-gun (JP); Katsuki MIYAMOTO, Suwa-gun (JP)

(21) Appl. No.: 14/315,600

(22) Filed: Jun. 26, 2014

(30) Foreign Application Priority Data
Jun. 28, 2013 (JP) 2013-137510

(51) Int. Cl. G10F 1/06

(52) U.S. Cl. CPC G10F 1/06
USPC 84/97

(57) ABSTRACT

A music box includes a bed plate, a vibration plate, a plurality of projections, and a flange part. The vibration plate has one end portion fixed to the bedplate and another end portion provided with a plurality of vibration reeds extending in a first direction. The plurality of projections is configured to contact the plurality of vibration reeds and corresponds to the plurality of vibration reeds. The flange part protrudes from the bedplate in the first direction and confronts the plurality of vibration reeds.

### CROSS REFERENCE TO RELATED APPLICATION

This application claims priority from Japanese Patent Application No. 2013-137510 filed Jun. 28, 2013. The entire content of this priority application is incorporated herein by reference.

### TECHNICAL FIELD

The present invention relates to a music box, and particularly to an improved music box that achieves a desired sound quality.

### BACKGROUND

Music boxes that play music are well known in the art. One such music box includes a flat vibration plate having a plurality of vibration reeds lying on a prescribed plane, for example. Each of the vibration reeds corresponds to different pitches and produces sounds at the corresponding pitches upon being plucked.

Various technologies have been proposed for improving the sound quality of such music boxes. The conventional technology discloses a pin structure including a pair of strips for each note that the music box can produce. One strip in each pair functions as a vibration reed that is plucked to produce a sound for each note, while the other strip functions as a vibration plate positioned alongside the vibration reed. The other strip vibrates in response to vibrations of the vibration reed. Thus, a plucked vibration reed and its corresponding vibration plate exhibits a tuning-fork effect that enhances the quality of sound produced from the vibration reed.

### SUMMARY

However, since space exists in the music box between a plucked vibration reed and the neighboring vibration reeds for other pitches, as well as between the plucked vibration reed and the vibration plate confronting that vibration reed, the vibrations in the plucked vibration reed are not sufficiently propagated to the vibration plate other than the confronting vibration plate shaped in the form of strip in the conventional technology described above.

The pin structure in a music box is commonly configured of a single plate provided with a plurality of vibration reeds. However, when the pin structure has this single plate configuration including the plurality of vibration reeds without the vibration plate, sound produced from a plucked vibration reed is more likely to escape than be propagated to other strip as the vibration plate and the like. Accordingly, the sound produced from a vibration reed tends to decay rather than be transmitted as vibrations and resonated.

In view of the foregoing, it is an object of the present disclosure to provide a music box capable of achieving a desired sound quality.

In order to attain the above and other objects, the present disclosure provides a music box. The music box may include a bed plate, a vibration plate, a plurality of projections, and a flange part. The vibration plate may have one end portion fixed to the bedplate and another end portion provided with a plurality of vibration reeds extending in a first direction. The plurality of projections may be configured to contact the plurality of vibration reeds and each of the plurality of projections may correspond to each of the plurality of vibration reeds. The flange part may protrude from the bedplate in the first direction and confront the plurality of vibration reeds.

According to another aspect of the disclosure, the disclosure provides a music box. The music box may include a bedplate, a vibration plate, a plurality of projections, and a flange part. The vibration plate may have one end portion fixed to the bedplate. The vibration plate may comprise a plurality of vibration reeds extending from the one end portion in a first direction. Each of the plurality of projections may be configured to confront each of the plurality of vibration reeds. The flange part may protrude from the bedplate in the first direction and confront the plurality of vibration reeds.

Preferably, the plurality of vibration reeds has a different reed length from each other in the first direction. The plurality of vibration reeds is arranged in a second direction crossing the first direction in order of increasing the reed length thereof The plurality of vibration reeds has a first region in which a first predetermined number of vibration reeds including a vibration reed having a longest reed length is provided, a second region in which a second predetermined number of vibration reeds including a vibration reed having a shortest reed length is provided, and a third region other than the first region and the second region. The first predetermined number of vibration reeds is neighboring with each other, and the second predetermined number of vibration reeds is neighboring with each other. The flange part comprises a first flange part confronting the first region and a second flange part confronting the second region. The flange part is offset from the third region. The first predetermined number is unequal or equal to the second predetermined number.

### BRIEF DESCRIPTION OF THE DRAWINGS

For a more complete understanding of the present disclosure, and the objects, features, and advantages thereof, reference now is made to the following descriptions taken in connection with the accompanying drawings.

FIG. 1 is a schematic perspective view of a music box according to one or more aspects of the disclosure.

FIG. 2 is a schematic view showing a mechanical performance unit of the music box as viewed from an axial direction of a first shaft according to one or more aspects of the disclosure.

FIG. 3 is a perspective view of the mechanical performance unit shown in FIG. 2 according to one or more aspects of the disclosure.

FIG. 4 is a plane view of a vibration plate and a bedplate each provided in the music box according to one or more aspects of the disclosure.

FIG. 5 is a cross-sectional view taken along a line V-V of FIG. 4 according to one or more aspects of the disclosure according to one or more aspects of the disclosure.

FIG. 6 is a schematic view of the mechanical performance unit when a projection of a star wheel plucks a vibration reed of the vibration plate according to one or more aspects of the disclosure.

FIG. 7 is a schematic view of an enclosure for accommodating therein the mechanical performance unit according to one or more aspects of the disclosure.

FIG. 8 is a block diagram of control functions of an electric control unit in the music box according to one or more aspects of the disclosure.

FIG. 9 is a plane view of a vibration plate and a bedplate each provided in a music box according to one or more aspects of the disclosure.

FIG. 10 is a plane view of a vibration plate and a bedplate each provided in a music box according to one or more aspects of the disclosure.

FIG. 11 is a plane view of a vibration plate and a bed plate each provided in a music box according to one or more aspects of the disclosure.

FIG. 12 is a schematic view of a conventional music box.

### DETAILED DESCRIPTION

Next, a music box 10 according to a preferred embodiment of the present disclosure will be described while referring to the accompanying drawings.

In the preferred embodiment, the top of the music box 10 will be considered the uppermost portion of the music box 10 in a general vertical direction when the music box 10 is resting on a flat surface (not shown).

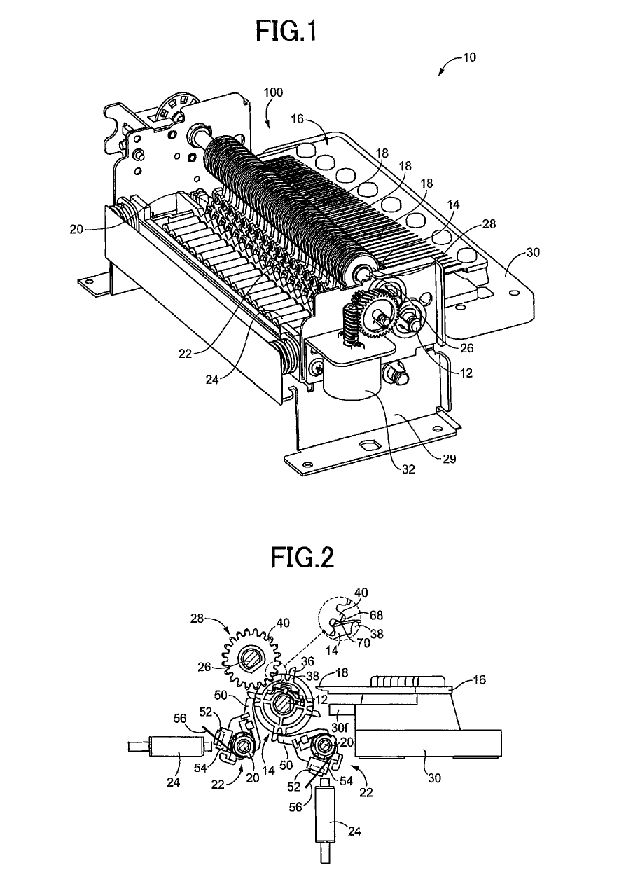

As shown in FIG. 1, the mechanical performance unit 100 includes a first shaft 12; a plurality (forty in this example) of star wheels 14 rotatably provided on the first shaft 12; a vibration plate 16 provided alongside the first shaft 12 and each having a plurality of vibration reeds 18 juxtaposed along the first shaft 12 at positions corresponding to the star wheels 14; a pair of second shafts 20 arranged along the first shaft 12, and preferably parallel to the first shaft 12; a plurality of anchoring members 22 pivotally movable about each of the second shafts 20 and provided at positions corresponding to the each of the star wheels 14; a plurality of electromagnets 24 disposed in positions corresponding to the anchoring members 22; a third shaft 26 arranged parallel to the first shaft 12; a plurality of sun wheels 28 provided on the third shaft 26 at positions corresponding to the star wheels 14 so as to rotate together with and not relative to the third shaft 26; a frame 29 for rotatably supporting the first shaft 12 and the third shaft 26 about their center axes, non-rotatably supporting the second shafts 20, and serving as a mounting base for the electromagnets 24; a bedplate 30 on which the vibration plate 16 is fixed; and a motor 32 adapted to produce a drive force for driving the first shaft 12 and the third shaft 26 to rotate about their axes in synchronization. The vibration reeds 18 correspond to discrete predetermined musical tones and produce a sound at the corresponding tone when plucked by a claw 36 (described later) on the corresponding star wheel 14. The mechanical performance unit 100 shown in FIG. 1 is accommodated in an enclosure 34 of the music box 10 described below by assembling the frame 29 and the bedplate 30 to the enclosure 34.

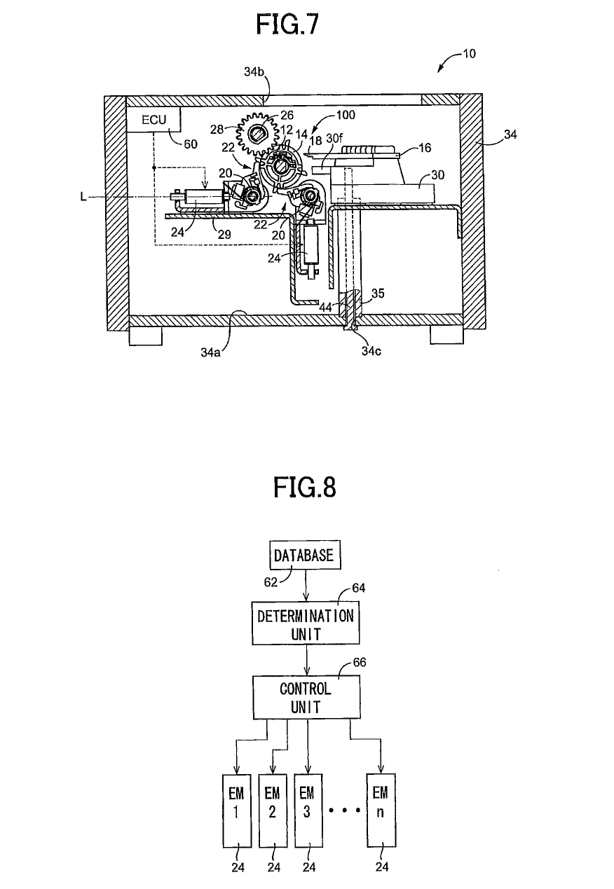

As shown in FIG. 7, the music box 10 is provided with the enclosure 34 for accommodating therein the first shaft 12, the star wheels 14, the vibration plate 16, the second shafts 20, the anchoring members 22, the electromagnets 24, the third shaft 26, and the sun wheels 28 or the like. That is, the mechanical performance unit 100 having the structure shown in FIG. 1 is accommodated inside the enclosure 34 by mounting the frame 29 and the bedplate 30 on the enclosure 34. The enclosure 34 defines an inner bottom surface as a resonant plate 34a, and includes a viewing window 34b. The resonant plate 34a functions to resonate with the vibrations of the vibration reeds 18. The bedplate 30 is fixed either directly or indirectly to the resonant plate 34a. The bedplate 30 is preferably fixed to the resonant plate 34a indirectly by connecting a sound post 35 (as an example of a predetermined member) in between the bedplate 30 and resonant plate 34a. Alternatively, the bedplate 30 may be placed directly on and fixed to the resonant plate 34a.

As indicated by a chain line L in FIG. 7, the center of the second shaft 20 and at least some of the electromagnets 24 are arranged in the same plane, which is parallel to the resonant plate 34a of the enclosure 34. That is, some of the electromagnets 24 extending in horizontal direction are arranged in the plane indicated by the chain line L, and remaining of the electromagnets 24 extending in vertical direction are shifted from the plane. Note that all of the electromagnets 24 may be arranged parallel to the inner resonant plate 34a of the enclosure 34.

The viewing window 34b is provided in the flat upper wall constituting the enclosure 34 to reveal the components inside the enclosure 34. The viewing window 34b is provided with a cover part (not shown) formed of glass or another transparent material. As shown in FIG. 7, the music box 10 also includes an electric control unit (ECU) 60 adapted to control the excitation and non-excitation of each electromagnet 24.

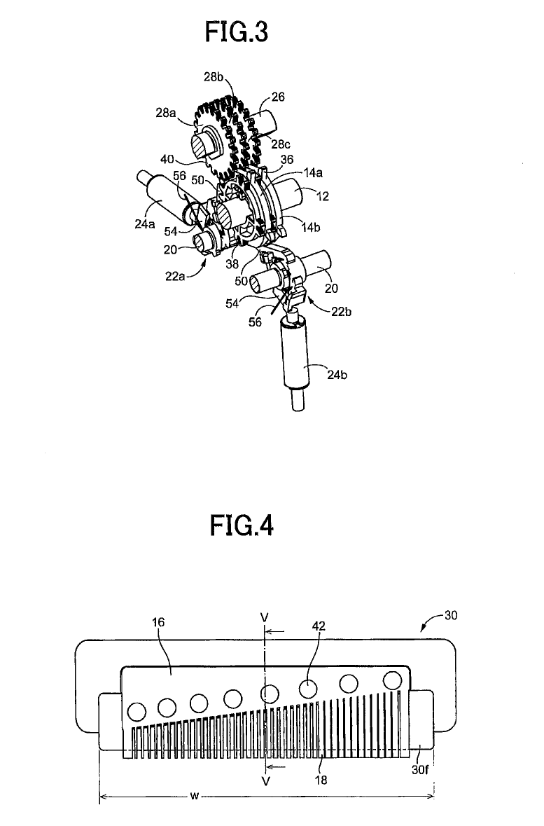

FIG. 2 is a view of the mechanical performance unit 100 in the music box 10 along the axial direction of the first shaft 12 illustrating the structures of the star wheels 14, the anchoring members 22, the sun wheels 28, and the like. FIG. 3 is a perspective view from an angle obliquely above the mechanical performance unit 100 illustrating the structures of the star wheels 14, the anchoring members 22, the sun wheels 28, and the like. FIG. 3 shows two star wheels 14a and 14b of the plurality of star wheels 14 and two electromagnets 24a and 24b for the corresponding engaging members 22a and 22b. FIG. 3 also illustrates the sun wheels 28a and 28b for the star wheels 14a and 14b and the sun wheel 28c neighboring the same. Here, a neighboring sun wheel 28 is defined as a sun wheel 28 positioned next to another sun wheel 28 along the third shaft 26.

In all drawings other than FIG. 3, where it is not necessary to distinguish among individual star wheels 14a and 14b, each star wheel is simply referred to using the reference numeral 14. Similarly, engaging members are simply referred to using the reference numeral 22 when it is not necessary to distinguish between individual engaging members 22a and 22b, and sun wheels are simply referred to using the reference numeral 28 when it is not necessary to distinguish among individual sun wheels 28a, 28b, and 28c.

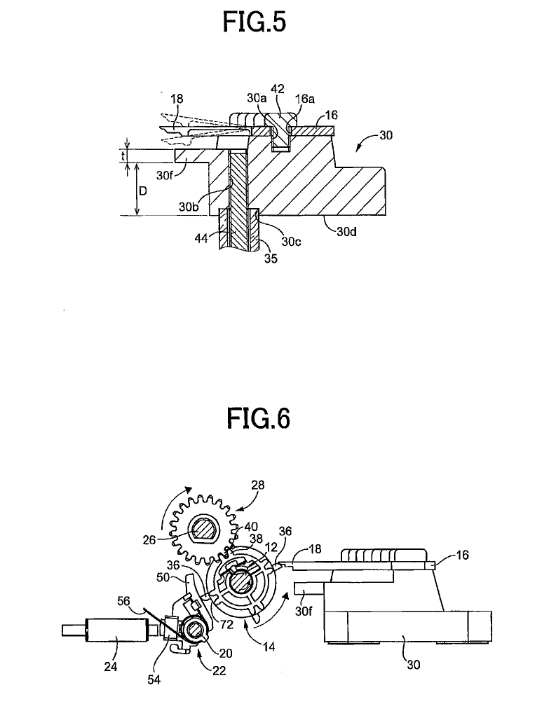

The example of FIG. 2 omits the depiction of the frame 29 and the sound post 35. The same is true with respect to FIG. 6. The vibration plate 16, the frame 29, and the bedplate 30 have been omitted from FIG. 3 while portions of the first shaft 12, the second shaft 20, and the third shaft 26 are also omitted (cut).

As shown in FIGS. 2 and 3, each star wheel 14 is provided with a plurality of claws 36 as projections protruding radially outward from the peripheral edge thereof. Preferably, four of the claws 36 are provided at equal intervals, i.e., at every 90 degrees, around the periphery of the star wheel 14 in the circumferential direction thereof. A plurality of gear teeth 38 are formed at a position radially inside of the claws 36. Preferably two of the gear teeth 38 are provided at positions corresponding to each claw 36. The gear teeth 38 are arranged between the star wheel 14 and the adjacent star wheel 14 in the first shaft 12 and, hence, are disposed at different positions from the claws 36 with respect to the axial direction of the first shaft 12. In other words, the gear teeth 38 are positioned between pairs of neighboring claws 36 with respect to the axial direction of the first shaft 12.

Each sun wheel 28 is provided with a plurality of gear teeth 40 around its peripheral edge. When the star wheel 14 is assembled on the first shaft 12 as shown in FIG. 2, the claws 36 are disposed at positions for contacting at least a portion of the vibration reed 18 aligned with the rotational path of the claws 36 upon the rotation of the star wheel 14 about the first shaft 12, i.e., the locus of the claw 36 is overlapped with the vibration reed 18. Further, the positions of the claws 36 are disposed at positions such that the anchoring member 22 can engage the claws 36 in an anchoring state described later. That is, when the anchoring member 22 contacts one of the claws 36, the star wheel 14 is prevented from following the rotation of the first shaft 12. By contacting the claw 36 after the claw 36 has plucked the corresponding vibration reed 18 on the vibration plate 16, the anchoring member 22 functions as a stopper for preventing the star wheel 14 from continuing to follow the rotation of the first shaft 12. The rotational path of the gear teeth 38 about the axial center of the first shaft 12 is aligned with the corresponding gear teeth 40 of the sun wheel 28 so that the gear teeth 38 can engage with the gear teeth 40 provided on the sun wheel 28.

As illustrated in the enlarged view of FIG. 2 (the portion encircled by a dashed line), the gear teeth 40 of the sun wheel 28 is formed with chamfered edges 68 at the distal ends of the gear teeth 40 and preferably on both sides in the axial direction of the sun wheel 28. Chamfered edges 70 are formed on the outer circumferential edges of the star wheels 14. The star wheel 68 defines an outer circumferential surface 72 (FIG. 6) formed with the chamfered edges 70. The star wheel 14 has two outer edges in the axial direction on the outer circumferential surface 72. At least one of the chamfered edges 68 on the sun wheel 28 and the chamfered edges 70 on the star wheel 14 may be formed. In addition to the chamfered edges 70 formed in the circumferential surface 72 of the star wheel 14, chamfered edges may be formed in the edges of the claws 36 (both axial edges) and the like.

As shown in FIG. 2, the anchoring member 22 includes a plate member 50, a magnetic member 52, a synthetic resin member 54, and a torsion coil spring 56. The plate member 50 is adapted to contact one of the claws 36 on the corresponding star wheel 14 by rotating the anchoring member 22 toward the star wheel 14 about the second shaft 20. The magnetic member 52 reacts to the magnetic force of the electromagnet 24 so as to rotate the anchoring member 22 in a direction for separating the anchoring member 22 from the star wheel 14. The magnetic member 52 is formed of metal whose primary component is an iron group element, such as iron, cobalt, or nickel. The magnetic member 52 is preferably an iron sheet that is not necessarily magnetized, but may be a permanent magnet (which is magnetized). The magnetic member 52 is formed in the synthetic resin member 54 through insert molding. In other words, the magnetic member 52 is embedded in the synthetic resin member 54. The synthetic resin member 54 is formed of an engineering plastic or the like provided integrally with the plate member 50. This construction can reduce chattering in the magnetic member 52 caused by the attraction of the electromagnet 24.

The electromagnet 24 is preferably configured of a cylindrical coil disposed around an iron core or other magnetic material. When electricity is supplied to the coil, the electromagnet 24 enters an excitation state in which a magnetic force (magnetic field) is produced. In the preferred embodiment, when the electricity is flowing through the coil, the electromagnet 24 is in the excitation state, whereas when electricity is not flowing through the coil, the electromagnet 24 remains in a non-excitation state. In other words, the electromagnet 24 is a common electromagnet known in the art.

Next, the engaging and disengaging operations of the anchoring member 22 will be described with reference to FIG. 8. As shown in FIG. 8, the ECU 60 includes a musical score database 62, a release timing determination unit 64, and an electromagnet excitation control unit 66.

The musical score database 62 stores data for a plurality of musical scores corresponding to songs or melodies for the music box 10 to play. The musical score database 62 may be stored on a storage medium, such as an SD card (Secure Digital card) well known in the art, and the ECU 60 is capable of reading the data stored on the storage medium. The musical scores is, for example, stored in a data format such as MIDI (Musical Instrument Digital Interface) and includes a plurality of tracks (channels) for a predetermined plurality of instrument types, wherein the output timing, tone, and the like for sounds is specified for each instrument. As is described below in greater detail, the music box 10 according to the preferred embodiment can control a musical performance based on output timings, musical tones, and the like of each track (channel) corresponding to the melodic theme of the MIDI data, for example.

The release timing determination unit 64 determines a release timing at which each of the anchoring members 22 releases the engagement with the claw 36 of the corresponding star wheel 14. In other words, the release timing determination unit 64 determines the release timing for switching the excitation/non-excitation state of the electromagnet 24 corresponding to each of the anchoring members 22 (the release timing at which electricity to the electromagnets 24 is conducted and halted). For example, while the mechanical performance unit 100 is performing a melody corresponding to prescribed data for one of the musical scores stored in the musical score database 62, the release timing determination unit 64 performs the above determinations based on the output timing and musical tone for each sound specified in the musical score data. More specifically, the release timing determination unit 64 determines the release timing at which each anchoring member 22 releases the claw 36 of the corresponding star wheel 14 in order that the vibration reeds 18 corresponding to the various musical tones are plucked at the output timings set in the musical score data.

When the rotations of the first shaft 12 and the third shaft 26 are set to constant speeds, a time lag is previously determined for indicating a period of time from when the anchoring member 22 releases the claw 36 of the corresponding star wheel 14 to when the claw 36 plucks the corresponding vibration reed 18. The release timing determination unit 64 determines the release timing based on the musical score data for the melody being played. The output timing for the musical tone corresponding to each vibration reed 18 is specified in the musical score data. Thus, the release timing determination unit 64 determines the release timing such that the anchoring member 22 corresponding to the vibration reed 18 releases the claw 36 of the corresponding star wheel 14 prior to the output timing by a length of time equivalent to the time lag.

The electromagnet excitation control unit 66 switches the state of each electromagnet 24 between the excitation state and the non-excitation state based on the determination results of the release timing determination unit 64. In other words, the electromagnet excitation control unit 66 controls the timing at which electricity is conducted to, and not conducted to, each of the electromagnets 24 based on the determination results of the release timing determination unit 64. For example, when the release timing determination unit 64 has determined the release timing at which the anchoring member 22 releases the claw 36 of the corresponding star wheel 14, the electromagnet excitation control unit 66 switches the state of the corresponding electromagnet 24 from the non-excitation state to the excitation state based on this timing. Hence, the electromagnet excitation control unit 66 begins conducting electricity to the electromagnet 24 at this timing. After switching the electromagnet 24 from the non-excitation state to the excitation state, the electromagnet excitation control unit 66 preferably switches the electromagnet 24 back to the non-excitation state after a predetermined time has elapsed. Hence, the electromagnet excitation control unit 66 halts the conduction of electricity at this timing.

As shown in FIG. 2, the electromagnet 24 is provided for each of the anchoring members 22. The electromagnet 24 is positioned near the synthetic resin member 54 of the anchoring member 22 having the embedded magnetic member 52, but is separated from the magnetic member 52 so as not to contact the same. That is, a prescribed gap is formed between the magnetic member 52 and the electromagnet 24 whether the anchoring member 22 is in an anchoring state or a non-anchoring state described later. This gap should fall within a range in which the magnetic force of the electromagnet 24 can affect the magnetic member 52 upon the excitation of the electromagnet 24. For example, the gap should be designed such that the magnetic force of the excited electromagnet 24 will attract the magnetic member 52, even when the anchoring member 22 is farthest from the electromagnet 24. Moreover, the gap should be set such that the attracting force of the electromagnet 24 can rotate the anchoring member 22 in a direction away from the star wheel 14. Preferably, the axial center of the electromagnet 24 (central axis of the iron core) is configured to intersect the rotational center of the anchoring member 22 (i.e., the axial center of the second shaft 20), as will be described later.

As shown in FIGS. 2 and 3, the torsion coil spring 56 preferably urges the anchoring member 22 and the plate member 50 toward the star wheel 14 when the electromagnet 24 is in the non-excitation state. Then, the plate member 50 is in an anchoring state (see FIG. 6 described later) for anchoring at the claws 36 provided on the corresponding star wheel 14. However, when the electromagnet 24 is in the excitation state, the magnetic force of the electromagnet 24 causes the anchoring member 22 and the plate member 50 to rotate about the second shaft 20 in a direction away from the star wheel 14 against the urging force of the torsion coil spring 56. The anchoring member 22 comes into a halt at a position in which the force of attraction on the magnetic member 52 corresponding to the magnetic force of the electromagnet 24 is counterbalanced by the urging force of the torsion coil spring 56. In this position, the anchoring member 22 is in the non-anchoring state (see FIG. 6 described later) in which the plate member 50 no longer anchors the claw 36. That is, the anchoring member 22 and the electromagnet 24 is an example of a drive control unit for controlling the drive of the star wheel 14.

As illustrated in FIGS. 2 and 3, the electromagnets 24 and the anchoring members 22 corresponding to these electromagnets 24 belong to either a first group or a second group. The electromagnets 24 and the anchoring members 22 belonging to the first group are arranged at a 90-degree phase differential about the axial center of the first shaft 12 (at a position for forming an angle of 90 degrees) with the electromagnets 24 and the anchoring members 22 belonging to the second group. If the electromagnets 24 were numbered from 1 to n from one end of the second shafts 20 to the other, the electromagnets 24 with odd numbers preferably belong to the first group while those with even numbers preferably belong to the second group. Thus, the electromagnets 24, such as the electromagnets 24a and 24b in FIG. 3 corresponding to the pair of adjacent star wheels 14a and 14b, are preferably arranged apart from each other by a phase of 90 degrees about the axial center of the first shaft 12. This configuration minimizes the space required for arranging the mechanical performance unit 100 (and particularly the electromagnets 24) in the music box 10, thereby reducing the size of the music box 10.

FIGS. 2 and 6 detail the operations of the mechanical performance unit 100 having the structure described above. When the music box 10 is playing a melody, the first shaft 12 and the third shaft 26 are constantly and synchronously driven by the motor 32 to rotate about their axial centers. As indicated by arrows in FIG. 6, the first shaft 12 and the third shaft 26 are driven to rotate in opposite directions. The first shaft 12 is preferably rotated such that the claws 36 provided on each star wheel 14 move in a direction for plucking the corresponding vibration reeds 18 of the corresponding vibration plate 16 upward. The third shaft 26 is rotated so that the star wheels 14 are driven to rotate in the direction indicated by the arrow when the gear teeth 38 of the star wheels 14 are engaged with the gear teeth 40 of the corresponding sun wheels 28. Since the sun wheels 28 are incapable of rotating relative to the third shaft 26, the sun wheels 28 are constantly rotated about their axial centers as the third shaft 26 rotates about its axial center while the music box 10 is playing a melody.

FIG. 2 illustrates the operations of the mechanical performance unit 100 when the anchoring member 22 is in the anchoring state. In the state shown in FIG. 2, electricity is not being supplied to the electromagnet 24 and thus the electromagnet 24 is in the non-excitation state. At this time, the torsion coil spring 56 urges the plate member 50 of the anchoring member 22 so that the anchoring member 22 is rotated toward the star wheel 14 and one of the claws 36 on the corresponding star wheel 14 is anchored by the anchoring member 22. That is, one of the claws 36 contacts the distal end of the plate member 50 on the downstream side with respect to the rotating direction of the first shaft 12 (the side in which the rotation progresses).

The star wheel 14 is configured to follow the rotation of the first shaft 12 through the frictional force generated at the point of contact with the first shaft 12.

In the state shown in FIG. 2, the anchoring member 22 is in the anchoring state for preventing the star wheel 14 from following the rotation of the first shaft 12, despite the frictional force at the contact point therebetween. That is, the star wheel 14 provided on the first shaft 12 rotates relative to the first shaft 12, with the surfaces of contact between the assembly hole 46 of the star wheel 14 and the first shaft 12 sliding over each other with a light load, while the phase of the star wheel 14 (the positional relationship of the star wheel 14 relative to the vibration reed 18 and the like) remains fixed. In this state, the gear teeth 38 on the star wheel 14 are not engaged with the gear teeth 40 on the sun wheel 28 and, hence, the rotation of the sun wheel 28 does not affect the rotation of the star wheel 14.

Next, the operations of the mechanical performance unit 100 will be described when the anchoring member 22 is switched from the anchoring state shown in FIG. 2 to the non-anchoring state shown in FIG. 6. When electricity is conducted to the electromagnet 24 while the mechanical performance unit 100 is in the state shown in FIG. 2, the electromagnet 24 is brought into the excitation state. The magnetic force produced by the electromagnet 24 causes the plate member 50 of the anchoring member 22 to rotate about the second shaft 20 against the urging of the torsion coil spring 56 in a direction away from the star wheel 14. Consequently, the plate member 50 that has anchored the claw 36 disengages therefrom, enabling the star wheel 14 to rotate together with the first shaft 12 due to the frictional force generated at the area of contact between the star wheel 14 and the first shaft 12.

When the electromagnet 24 is brought into the excitation state and the magnetic member 52 is closest to the axial center of the electromagnet 24 at the distal end thereof, the electromagnet 24 and the magnetic member 52 are not in contact with each other with a gap therebetween. The magnetic member 52 defines a curved surface on the electromagnet 24 side having a columnar shape centered on the second shaft 20. Hence, the gap between the electromagnet 24 and the magnetic member 52 will not change when the anchoring member 22 is rotated about the second shaft 20.

FIG. 6 illustrates the operations of the mechanical performance unit 100 for playing a sound by plucking the vibration reed 18 of the vibration plate 16 with the corresponding claw 36 on the star wheel 14. In this operation, the electromagnet 24 is in the non-anchoring state, causing the plate member 50 to disengage from the claw 36. Subsequently, the star wheel 14 begins to follow the rotation of the first shaft 12 due to the frictional force generated at the area of contact between the first shaft 12 and the star wheel 14. When the star wheel 14 is near a phase in which one of the claws 36 contacts the corresponding vibration reed 18 on the vibration plate 16, the corresponding gear teeth 38 adjacent to the claw 36 in the rotating direction (at a phase difference of 90 degrees in the rotating direction) are brought into engagement with the gear teeth 40 on the sun wheel 28. In this state, the rotation of the sun wheel 28 drives the star wheel 14 in the direction of the arrow indicated in FIG. 6, i.e., in a direction for moving the claw 36 upward to pluck the vibration reed 18 on the vibration plate 16. Through this operation, a sound at the tone corresponding to the vibration reed 18 is played.

After the claw 36 plucks the corresponding vibration reed 18, the star wheel 14 follows the rotation of the first shaft 12 and then the gear teeth 38 is brought into disengagement from the gear teeth 40 on the sun wheel 28. The electricity to the electromagnet 24 is halted and the electromagnet 24 is brought into the non-excitation state at a time in a period from when the electricity to the electromagnet 24 is conducted and the gear teeth 38 is brought into engagement with the gear teeth 40 to when the gear teeth 38 is brought into disengagement from the gear teeth 40. Thus, the torsion coil spring 56 urges the anchoring member 22 against the star wheel 14, returning the state shown in FIG. 2.

As shown in FIGS. 4 and 5, the vibration plate 16 has one end portion fixed to the bedplate 30 and another end portion on which the vibration reeds 18 are provided. The vibration plate 16 is preferably fixed to the bedplate 30 on the opposite end portion from the end portion which the vibration reeds 18 are provided. As shown in FIGS. 4 and 5, a plurality (eight in the preferred embodiment) of female threaded holes 30a is preferably formed in the top portion of the bedplate 30 where the vibration plate 16 is mounted. Through-holes 16a are formed in the vibration plate 16 at positions corresponding to the threaded holes 30a. The vibration plate 16 is fixed to the bedplate 30 by inserting a plurality (eight in the preferred embodiment) of screws 42 through the through-holes 16a and threadingly engaging the screws 42 with the corresponding threaded holes 30a. While screws are used to fasten the vibration plate 16 to the bedplate 30 in the preferred embodiment, the vibration plate 16 may be fixed to the bedplate 30 with adhesive, or through welding, brazing, or the like.

As shown in FIG. 4, the vibration plate 16 is provided with a plurality (forty, for example) of the vibration reeds 18. In the preferred embodiment, the vibration reeds 18 are integrally formed with the vibration plate 16 such that one end of each vibration reed 18 is a free end and the other is a fixed end. The bedplate 30 is provided with fixing parts to which the fixed ends of the vibration reeds 18 are fixed. The fixing parts of the bedplate 30 are arranged at regular intervals that match the intervals between fixed ends of the vibration reeds 18. In the preferred embodiment, the threaded holes 30a, screws 42, and the like are an example of these fixing parts.

As shown in FIG. 1 and other drawings, the plurality of vibration reeds 18 is arranged to correspond to the plurality of star wheels 14. A vibration reed 18 corresponds to a star wheel 14, which means that the claws 36 provided on the star wheel 14 are in a position capable of plucking the vibration reed 18. When the vibration plate 16 is mounted on the bedplate 30, the vibration reeds 18 are arranged along the first shaft 12. The vibration reeds 18 uniquely correspond to a plurality of predetermined pitches and, when plucked by claws 36 on the corresponding star wheels 14, produce sound at the corresponding pitches, as will be described later. Hence, the vibration reeds 18 function as the sounding bodies of the music box 10. In other words, each of the vibration reeds 18 produces sound at a different frequency when plucked by the claw 36 on the corresponding star wheel 14.

For this reason, each of the vibration reeds 18 has different properties.

For example, the longitudinal dimensions of the vibration reeds 18 differ according to pitch, as illustrated in FIG. 4. Hereinafter, the longitudinal dimension of each vibration reed 18 will be called the reed length. The reed length is the length of the vibration reed 18 in a direction orthogonal to the juxtaposed direction of the vibration reeds 18. The dimension of the vibration reed 18 along the juxtaposed direction of the vibration reeds 18 will be called the reed width. Here, the reed length of a vibration reed 18 is shorter for higher pitches and longer for lower pitches. In other words, the vibration reed 18 having the highest pitch is the vibration reed 18 having the shortest reed length, while the vibration reed 18 having the lowest pitch is the vibration reed 18 having the longest reed length.

As shown in FIG. 4, the vibration reeds 18 are arranged on the vibration plate 16 in order of their reed lengths. Accordingly, the vibration reed 18 with the shortest reed length corresponding to the highest pitch is provided on one end of the plurality of vibration reeds 18 in their juxtaposed direction, while the vibration reed 18 having the longest reed length corresponding to the lowest pitch is provided on the other end. Thus, the vibration reeds 18 are juxtaposed in order of increasing reed length beginning from the vibration reed 18 with the shortest reed length on one end in the juxtaposed direction.

In addition, the pitch of the vibration reeds 18 becomes higher when the vibration reeds 18 are more slender, i.e., when the reed width of the vibration reeds 18 is smaller, and lower when the vibration reeds 18 are fatter, i.e., when the width dimension is greater. As shown in FIG. 4, the free ends of the vibration reeds 18 positioned on the star wheel 14 side are aligned with each other in the juxtaposed direction in the preferred embodiment, but the opposite ends, i.e., the fixed ends of the vibration reeds 18 may be aligned instead.

In the preferred embodiment, the bedplate 30 is fixed to the enclosure 34 through the columnar-shaped sound post 35. In other words, the sound post 35 is disposed between the bedplate 30 and the resonant plate 34a and is an example of the predetermined member fixed to both the bedplate 30 and the resonant plate 34a. The sound post 35 has a hollow tube shape, for example, and is made from wood, such as spruce. Alternatively, the sound post 35 may be formed of a metal.

As shown in FIGS. 5 and 7, a female threaded hole 30b is formed in a portion of the bedplate 30 (bottom surface) in which the sound post 35 is mounted. A circular recess 30c having a dimension matching the outer diameter of the sound post 35 is formed in a bottom surface 30d of the bedplate 30 so as to surround the threaded hole 30b. The resonant plate 34a is formed with a through-hole 34c at a position corresponding to the area in which the sound post 35 is mounted. One end of the sound post 35 is fitted into the recess 30c of the bedplate 30, while the other end is positioned such that its hollow center is substantially aligned with the through-hole 34c formed in the resonant plate 34a. With the sound post 35 in this position, a screw 44 is inserted through the through-hole 34c into the hollow center of the sound post 35 and is screwed into the threaded hole 30b of the bedplate 30, thereby fixing the bedplate 30, the sound post 35, and the resonant plate 34a to each other.

While only one sound post 35 may be preferably provided between the bedplate 30 and the resonant plate 34a, a plurality of sound posts may be provided instead. Further, the sound post 35 need not have a columnar shape, but may be configured as a square column or the like. The sound post 35 also need not be formed in the shape of a hollow tube. In this case, a screw is used to fasten one end of the sound post 35 to the bedplate 30, while another screw is used to fasten the other end of the sound post 35 to the resonant plate 34a.

As shown in FIGS. 4 and 5, the bedplate 30 is provided with a flange part 30f that protrudes like a brim from the bedplate 30. The flange part 30f is preferably formed integrally with and of the same material as the bedplate 30. The flange part 30f may be integrally formed with the bedplate 30 through zinc diecasting, for example, and is formed of a material having sufficient stiffness to either transmit or reflect vibrations produced by the vibration reeds 18. The thickness t of the flange part 30f, i.e., the vertical dimension of the flange part 30f (the dimension in the direction corresponding to the shortest distance between the flange part 30f and the vibration reed 18), is thinner than the thickness of the bedplate 30. For example, the thickness t of the flange part 30f is less than one-fourth the thickness of the bedplate 30. The width w of the flange part 30f, i.e., the dimension of the flange part 30f in the juxtaposed direction (the direction in which the plurality of vibration reeds 18 are juxtaposed), is at least greater than the same dimension of the vibration plate 16 as shown in FIG. 4. In relation to the vertical direction, the flange part 30f is preferably provided on the side of the bedplate 30 nearest the top surface thereof, i.e., the side on which the vibration plate 16 is fixed. In other words, the distance D between the bottom surface of the flange part 30f and the bottom surface 30d of the bedplate 30 is greater than 0. The flange part 30f is also positioned lower than the fixing part of the bedplate 30, i.e., the surface of the bedplate 30 that contacts the vibration plate 16. The flange part 30f is also preferably provided near the area of the bedplate 30 to which the sound post 35 is fixed. In other words, the sound post 35 is fixed to the bedplate 30 on the side closer to the flange part 30f than the center of the bedplate 30 with respect to the longitudinal direction of the vibration reeds 18.

The flange part 30f protrudes in the same direction that the vibration reeds 18 extend from the vibration plate 16 fixed to the bedplate 30. The flange part 30f is preferably arranged to be generally parallel to the vibration plate 16 and, thus generally parallel to the surface on which the vibration reeds 18 are provided. As shown in FIGS. 4 and 5, the flange part 30f is positioned to confront but not contact the plurality of vibration reeds 18. In other words, the flange part 30f occupies an area that at least overlaps a plurality of the vibration reeds 18 in a plan view, as shown in FIG. 4, i.e., the width of vibration plate 16 in a direction orthogonal to the juxtaposed direction of the vibration reeds 18 is longer than that of the flange part 30f in the direction. The dimension of the flange part 30f in the direction that it protrudes from the bedplate 30 corresponds to the reed length of the longest vibration reed 18, i.e., the reed length of the vibration reed 18 having the lowest pitch. That is, the dimension of the flange part 30f in the protruding direction thereof is approximately equal to or slightly shorter than the reed length of the vibration reed 18 having the lowest pitch.

When plucked by the claw 36 on the corresponding star wheel 14, the vibration reed 18 produces sound by the vertical vibration, as indicated by the dashed lines in FIG. 5. Here, a load is necessary to vibrate vibration reeds 18 having a short reed length at the same amplitude and thus, when released at the same height, vibration reeds 18 with a short reed length have greater energy and more speed. Consequently, the short vibration reeds 18 have a short oscillating period and a high frequency. Thus, the protruding dimension of the flange part 30f is preferably set such that the longest vibration reed 18 will not contact the flange part 30f upon the vibration after being plucked by the claw 36 of the corresponding star wheel 14.

As described above, the music box 10 according to the preferred embodiment includes the flange part 30f provided on the bedplate 30. The flange part 30f protrudes from the bedplate 30 in the direction that the vibration reeds 18 extend from the vibration plate 16 and is positioned to vertically confront a plurality of the vibration reeds 18. Vibrations in the vibration plate 16 are transmitted to the bedplate 30 to which the vibration plate 16 is directly fixed. Providing the flange part 30f increases the stiffness of the bedplate 30 at the base end of the vibration plate 16 and improves the transmission efficiency of vibrations of the bedplate 30, thereby improving the resonance of sounds produced through vibrations of the vibration reeds 18. In other words, sounds transmitted outside of the music box 10 in response to vibrations of the vibration reeds 18 become louder. Vibrations in vibration reeds 18 are transmitted from the bedplate 30 to the resonant plate 34a via the sound post 35. When the flange part 30f is positioned to confront the vibration reeds 18, the flange part 30f picks up the vibrations of the vibration reeds 18, i.e., the vibrations of the vibration reeds 18 is transmitted to the flange part 30f via the vertical interspace therebetween, and transmits these vibrations to the bedplate 30. Hence, sound produced by vibrating the vibration reeds 18 is readily transmitted to the resonant plate 34a via the bedplate 30 and the sound post 35.

Sound produced by vibrating the vibration reeds 18 also resonates in the top of the enclosure 34, i.e., the side of the enclosure 34 in which the viewing window 34b is provided. By providing the flange part 30f in a position confronting the vibration reeds 18, vibrations produced by the vibration reeds 18 are reflected off the flange part 30f and readily transmitted toward the top of the enclosure 34.

According to the principles described above, the flange part 30f provided on the bedplate 30 is thought to improve the resonance of sounds produced by vibrating the vibration reeds 18. Thus, the flange part 30f provided on the bedplate 30 in the music box 10 according to the preferred embodiment functions as a resonating part (augmenting part, reflecting plate) that resonates sounds produced by vibrating the vibration reeds 18 throughout the entire music box 10.

In order to further improve the sound quality of notes produced by vibrating the vibration reeds 18, the gaps between individual vibration reeds 18 and the flange part 30f may be set to correspond to the pitches (notes) of the corresponding vibration reeds 18. That is, the gap between the vibration reed 18 and the flange part 30f may be set in accordance with the frequency (wavelength) of sound produced by vibration of the vibration reed 18, and is preferably set such that the sound produced by vibrating the vibration reed 18 and the sound reflected off the flange part 30f reinforce each other. Hence, the gaps between the vibration reeds 18 and the flange part 30f need not be uniform, but may be configured to increase as the wavelength of sound corresponding to the vibration reed 18 increases. The flange part 30f may also be configured such that its thickness t is greater in areas corresponding to vibration reeds 18 with lower pitches.

As described above, the music box 10 according to the preferred embodiment is provided with the stoppers 22 and the electromagnets 24 for controlling driving of the star wheels 14. As shown in FIG. 7 and other drawings, the star wheels 14, the stoppers 22, and the electromagnets 24 are provided adjacent to the bedplate 30 along the direction in which the vibration plate 16 extends from the bedplate 30. In other words, the star wheels 14, the stoppers 22, and the electromagnets 24 are disposed adjacent to the flange part 30f in the direction that the flange part 30f protrudes from the bedplate 30.

FIG. 12 is a schematic diagram showing the structure of a common conventional music box 200. The conventional music box 200 shown in FIG. 12 includes a bedplate 202, a vibration plate 204 fixed to the bedplate 202, a plurality of vibration reeds 206 provided on the vibration plate 204, and a cylinder 208 provided with projections for plucking the plurality of corresponding vibration reeds 206. In this conventional music box 200, the bedplate 202 is configured to extend below the cylinder 208, as shown in FIG. 12. However, in the structure of a music box similar to the music box 10 according to the embodiment, the bedplate 30 cannot be easily arranged to extend beneath the star wheels 14 and their drive control unit since the star wheels 14 and the drive control unit are arranged next to the bedplate 30 along the extended direction of the vibration reeds 18. Hence, by providing the flange part 30f on the bedplate 30 so as to protrude from the bedplate 30 in the same direction that the vibration reeds 18 extend from the vibration plate 16 to confront the plurality of vibration reeds 18, as described above with reference to FIG. 4 and other drawings, the operations described above with reference to FIGS. 2 and 6 can be realized while improving the quality of sound produced by the vibrating vibration reeds 18.

Next, other embodiments of the present disclosure will be described with reference to the drawings. The volume and resonating properties of sounds may differ among the vibration reeds 18 in the low-pitch range, the vibration reeds 18 in the middle-pitch range, and vibration reeds 18 in the high-pitch range, depending on the structures (specifications) of the vibration reeds 18 and the claws 36 configured to produce sounds and the configuration and material composition each of the enclosure 34. In such cases, the shape of the flange part 30f provided on the bedplate 30 may be modified to suit the properties of the vibration plate in order to improve the acoustic properties of the music box. In the descriptions of the following embodiments, like parts and components to those described in the first embodiment are designated with the same reference numerals to avoid duplicating description.

### Second Embodiment

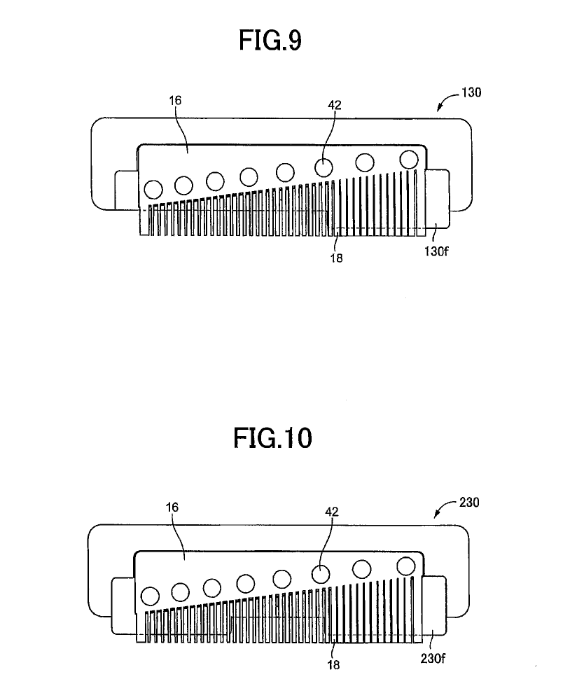

FIG. 9 is a plan view showing the vibration plate 16 and a bedplate 130, having a different structure than the bedplate 30 in the first embodiment, that are provided in the music box 10. As shown in FIG. 9, the vibration reeds 18 are arranged in order of their reed lengths. Accordingly, the vibration reed 18 with the shortest reed length corresponding to the highest pitch is provided on one end of the plurality of vibration reeds 18 in their juxtaposed direction, while the vibration reed 18 having the longest reed length corresponding to the lowest pitch is provided on the other end. As described in the first embodiment, the reed length of the vibration reed 18 is shorter for higher pitches and longer for lower pitches. Thus, the vibration reeds 18 are juxtaposed in order of increasing reed length, beginning from the vibration reed 18 with the shortest reed length on one end in the juxtaposed direction.

In the example of FIG. 9, the bedplate 130 is provided with a flange part 130f. The flange part 130f protrudes from the bedplate 130 on the other end of the flange part 130f relative to the juxtaposed direction of the vibration reeds 18 so as to confront a prescribed number (thirteen in the preferred embodiment) of vibration reeds 18 whose reed lengths are long. In other words, the flange part 130f protrudes on the other end for opposing the prescribed number of vibration reeds 18 on the low-pitch side in the juxtaposed direction.

In the preferred embodiment, the vibration reeds 18 are configured of three regions—a high-pitch region as an example of a second region, a medium-pitch region as an example of a third region, and a low-pitch region as an example of a first region—with each region accounting for one third of the vibration reeds 18. In a specific breakdown of how the forty vibration reeds 18 are divided, thirteen of the vibration reeds 18 occupy the high-pitch region, fourteen occupy the middle-pitch region, and thirteen occupy the low-pitch region. Thus, the flange part 130f does not protrude to a region confronting any vibration reeds 18 other than the prescribed number of vibration reeds 18 in the low-pitch region (vibration reeds 18 in the middle-pitch region and the high-pitch region, as an example of a second region). That is, on the middle-pitch region and high-pitch region sides, the flange part 130f does not protrude outward from the bedplate 130 along the longitudinal direction of the vibration reeds 18 so as to be offset from the vibration reeds 18. For example, if the sound produced by the vibration reeds 18 on the low-pitch side when plucked by the claws 36 of corresponding star wheels 14 is low due to the configuration of the vibration plate 16 and the like, the flange part 130f can be positioned to confront only the vibration reeds 18 on the low-pitch side, as shown in FIG. 9, thereby increasing the volume of sounds produced by these vibration reeds 18 while not changing the volume of sounds produced by the remaining vibration reeds 18. This arrangement achieves better balance across the entire range of sounds to produce uniform resonance for all notes. Therefore, the music box 10 according to the second embodiment can further improve the quality of sounds produced by vibrating the vibration reeds 18.

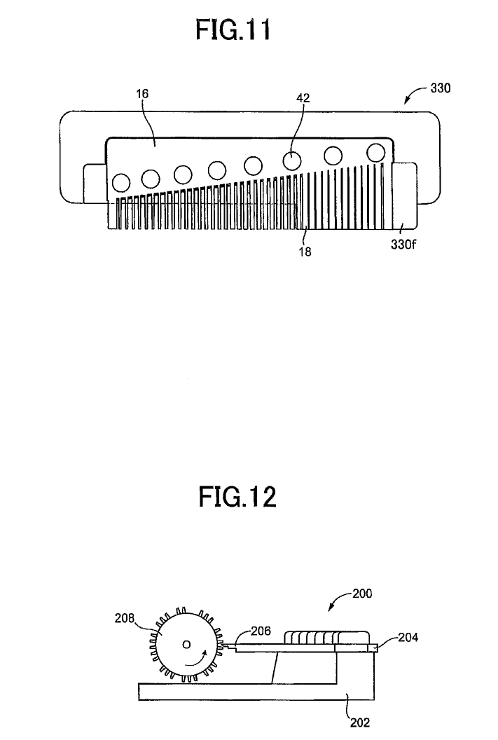

FIG. 11 is a plan view showing the vibration plate and a bedplate 330 according to a modification of the second embodiment, having a different structure than the bedplate 30 in the first embodiment. The vibration plate 16 and the vibration reeds 18 shown in FIG. 11 are the same as that in the second embodiment shown in FIG. 9. The bedplate 330 is provided with a flange part 330f. The flange part 330f has a length the same as that of the longest vibration reed 18. That is, the distal end of the flange part 330f is aligned with the tip end of the vibration reeds 18 on the low-pitch side in a plan view.

### Third Embodiment

FIG. 10 is a plan view showing the vibration plate 16 and a bedplate 230, having a different structure than the bedplate 30 in the first embodiment, that are provided in the music box 10. The vibration plate 16 and the vibration reeds 18 shown in FIG. 10 are the same as that in the second embodiment shown in FIG. 9.

In the example of FIG. 10, the bedplate 230 is provided with a flange part 230f. The flange part 230f is formed to protrude in two regions along the juxtaposed direction of the vibration reeds 18 so as to oppose a prescribed number (thirteen in the preferred embodiment) of vibration reeds 18 whose reed lengths are long, and a prescribed number (thirteen in the preferred embodiment) of vibration reeds 18 whose reed lengths are short. In other words, the flange part 230f protrudes to regions on both ends in the juxtaposed direction for opposing the prescribed number of vibration reeds 18 on the low-pitch side and the prescribed number of vibration reeds 18 on the high-pitch side. The flange part 230f is not provided in the region opposing vibration reeds 18 other vibration reeds 18 on the low-pitch and high-pitch sides (i.e., vibration reeds 18 corresponding to the middle-pitch region). That is, in the middle-pitch region, the flange part 230f does not protrude outward from the bedplate 230 along the longitudinal direction of the vibration reeds 18 so as to be offset from the vibration reeds 18.

For example, if sounds produced by vibration reeds 18 on the low-pitch side and high-pitch side when plucked by the claws 36 of the corresponding star wheels 14 are low due to the configuration of the vibration plate 16 and the like, the flange part 230f may be positioned to confront only vibration reeds 18 on the low-pitch side and high-pitch side, as shown in FIG. 10, thereby increasing the volume of sounds produced by these vibration reeds 18, while not changing the volume of sounds produced by vibration reeds 18 in the middle-pitch region. This configuration achieves better balance across the entire range of sounds to produce uniform resonance for all notes. Therefore, the music box 10 according to the third embodiment can further improve the quality of sounds produced by vibrating vibration reeds 18.

While the disclosure has been described in detail with reference to specific embodiments thereof, it would be apparent to those skilled in the art that many modifications and variations may be made therein without departing from the spirit of the disclosure, the scope of which is defined by the attached claims.

In short, the present disclosure is not limited to the structure described above with reference to FIGS. 1 through 10. For example, the number of claws 36 provided on each star wheel 14 is not limited to four and need not be arranged at 90-degree intervals around the periphery thereof Further, the gear teeth 38 need not be provided at positions corresponding to the claws 36 and may be positioned at different phases around the periphery of the star wheel 14.

Further, the electromagnets 24 and the anchoring members 22 belonging to the first group and the electromagnets 24 and the anchoring members 22 belonging to the second group need not be disposed at 90-degree intervals in a circumferential direction around the axial center of the first shaft 12. For example, all electromagnets 24 may be juxtaposed along the same plane. Conversely, if five or more of the claws 36 were provided around the periphery of the star wheel 14, for example, pluralities of the electromagnets 24 and anchoring members 22 could be arranged at positions corresponding to three or more phases spaced at prescribed phase differences in a circumferential direction around the axial center of the first shaft 12, depending on the number of claws 36 provided. Further, two or more of the anchoring members 22 may be provided for each star wheel 14 as the mechanism for anchoring the star wheel 14.

The ECU 60 may also be connected to the Internet or another communication link and may be configured to download musical score data via the communication link and store this data in the musical score database 62.

In addition, the shape of the star wheel 14, structure of the anchoring member 22 (shape of the plate member 50), phase positions of the various components, and the like may be modified as needed to suit the design of the music box. For example, the gear teeth 38 need not be provided in pairs, but may be provided in groups of one or three or more, provided that the sun wheel 28 can drive the star wheel 14 a sufficient distance and time interval for allowing the claw 36 to pluck the corresponding vibration reed 18 of the vibration plate 16.

The magnetic member of the anchoring member 22 may be configured of a permanent magnet. When the electromagnet 24 is in the excitation state, the magnetic force of the electromagnet 24 causes the permanent magnet to rotate the anchoring member 22 in a direction away from the star wheel 14. The permanent magnet is preferably formed in the synthetic resin member 54, which is integrally provided with the plate member 50, through insert molding, and is preferably positioned to produce a repelling force (force of repulsion between like magnetic poles) with the electromagnet 24 when the electromagnet 24 is excited.

The magnetic force of the electromagnet 24, i.e., the force of repulsion produced between the electromagnet 24 and the permanent magnet, moves the plate member 50 of the anchoring member 22 against the urging force of the torsion coil spring 56. Accordingly, the anchoring member 22 rotates about the second shaft 20 in a direction away from the star wheel 14, thereby disengaging the plate member 50 from the claw 36 and placing the anchoring member 22 in the non-anchoring state.

What is claimed is:

1. A music box comprising:
a bedplate;
a vibration plate having one end portion fixed to the bedplate and another end portion provided with a plurality of vibration reeds extending in a first direction;
a plurality of projections configured to contact each of the plurality of vibration reeds, each of the plurality of projections corresponding to each of the plurality of vibration reeds; and
a flange part protruding from the bedplate in the first direction and confronting the plurality of vibration reeds.

2. The music box according to claim 1, wherein the plurality of vibration reeds has a different reed length from each other in the first direction, the reed length of each of the plurality of vibration reeds corresponding to tone pitch, one of the plurality of vibration reeds having a longest reed length in the first direction, and
wherein the flange part has a flange length in the first direction corresponding to the longest reed length.

3. The music box according to claim 1, wherein the plurality of vibration reeds has a different reed length from each other in the first direction, the reed length of each of the plurality of vibration reeds corresponding to tone pitch, the plurality of vibration reeds being arranged in a second direction in order of increasing the reed length thereof, and
wherein the plurality of vibration reeds has a first region including a predetermined number of vibration reeds having a reed length longer than that of remaining vibration reeds and a second region other than the first region, and
wherein the flange part protrudes from the bedplate so as to confront the first region and be offset from the second region.

4. The music box according to claim 1, wherein the plurality of vibration reeds has a different reed length from each other in the first direction, the reed length of each of the plurality of vibration reeds corresponding to tone pitch, the plurality of vibration reeds being arranged in a second direction in order of increasing the reed length thereof, and
wherein the plurality of vibration reeds has a first region including a predetermined number of vibration reeds having a reed length longer than that of remaining vibration reeds, a second region including a predetermined number of vibration reeds having a reed length shorter than that of remaining vibration reeds, and a third region other than the first region and the second region, and
wherein the bedplate defines a fixed surface to which the one end portion of the vibration plate is fixed, and
wherein the flange part extends parallel to the fixed surface and protrudes from the bedplate so as to confront the first region and the second region and be offset from the third region.

5. The music box according to claim 1, further comprising a resonant plate configured to resonant a vibration of the plurality of vibration reeds,
wherein the bedplate is directly or indirectly connected to the resonant plate so as to transmit a vibration of the flange part to the resonant plate.

6. A music box comprising:
a bedplate;
a vibration plate having one end portion fixed to the bedplate, the vibration plate comprising a plurality of vibration reeds extending from the one end portion in a first direction;
a plurality of projections each of which is configured to confront each of the plurality of vibration reeds; and
a flange part protruding from the bedplate in the first direction and confronting the plurality of vibration reeds.

7. The music box according to claim 6, wherein the plurality of vibration reeds has a different reed length from each other in the first direction, one of the plurality of vibration reeds having a shortest reed length in the first direction, and
wherein the flange part has a flange length longer than the shortest reed length.

8. The music box according to claim 6, wherein the plurality of vibration reeds has a different reed length from each other in the first direction, one of the plurality of vibration reeds having a longest reed length in the first direction, and
wherein the flange part has a flange length equal to the longest reed length.

9. The music box according to claim 6, wherein the plurality of vibration reeds are arranged in a second direction crossing the first direction, and
wherein the flange part has a width in the second direction longer than a width of the vibration plate in the second direction.

10. The music box according to claim 6, wherein the plurality of vibration reeds has a different reed length from each other in the first direction, the plurality of vibration reeds being arranged in a second direction crossing the first direction in order of increasing the reed length thereof, the plurality of vibration reeds having a first region in which a predetermined number of vibration reeds including a vibration reed having a longest reed length is provided and a second region other than the first region, the predetermined number of vibration reeds being neighboring with each other, and
wherein the flange part confronts the first region and is offset from the second region.

11. The music box according to claim 6, wherein the plurality of vibration reeds has a different reed length from each other in the first direction, the plurality of vibration reeds being arranged in a second direction crossing the first direction in order of increasing the reed length thereof, and
wherein the plurality of vibration reeds has a first region in which a first predetermined number of vibration reeds including a vibration reed having a longest reed length is provided, a second region in which a second predetermined number of vibration reeds including a vibration reed having a shortest reed length is provided, and a third region other than the first region and the second region, the first predetermined number of vibration reeds being neighboring with each other, the second predetermined number of vibration reeds being neighboring with each other, and
wherein the flange part comprises a first flange part confronting the first region and a second flange part confronting the second region, the flange part being offset from the third region.

12. The music box according to claim 6, further comprising a resonant plate configured to resonant a vibration of the plurality of vibration reeds,
wherein the bedplate is fixed to a predetermined member, and the resonant plate is fixed to the predetermined member.
